(19) United States
(12) Patent Application Publication
(10) Pub. No.: US 2017/0149480 A1
(43) Pub. Date: May 25, 2017

(54) BASE STATION, USER EQUIPMENT, AND RADIO COMMUNICATION NETWORK

(71) Applicant: NTT DOCOMO, INC., Tokyo (JP)

(72) Inventors: Yuichi Kakishima, Tokyo (JP); Satoshi Nagata, Tokyo (JP); Yang Song, Beijing (CN); Xiaolin Hou, Beijing (CN); Huiling Jiang, Beijing (CN)

(73) Assignee: NTT DOCOMO, INC., Tokyo (JP)

(21) Appl. No.: 15/323,345

(22) PCT Filed: Jun. 29, 2015
(86) PCT No.: PCT/JP2015/068628

§ 371 Date: Dec. 30, 2016

(30) Foreign Application Priority Data
Jul. 25, 2014 (JP) 2014-152085

(51) Int. Cl. H04B 7/0456; H04B 7/04; H04L 5/00

(52) U.S. Cl. CPC H04B 7/0456; H04L 5/0048; H04B 7/0421

(57) ABSTRACT

A base station has: a plurality of transmission antenna ports; a precoding weight generator that generates precoding weights for controlling directions of beams to be transmitted on at least one of the transmission antenna ports; and a reference signal transmission controller that precodes, with the precoding weights, a plurality of reference signals for measurements of reception qualities at a user equipment such that the plurality of reference signals are adapted respectively to a plurality of directions, and that transmits, on at least one of the transmission antenna ports, the plurality of precoded reference signals in a format that allows the user equipment to distinguish between the plurality of reference signals.

### TECHNICAL FIELD

The present invention relates to a base station, a user equipment, and a radio communication network.

### BACKGROUND ART

In the field of radio communication, a MIMO (Multiple-Input and Multiple-Output) transmission method is utilized, by which high-speed and high-quality signal transmission is realized, using a plurality of antennas at both a radio transmitting station and a radio receiving station.

In order to further increase the speed of signal transmission and reduce interference, technology has been proposed, for controlling the directions of beams by using a large number of transmission antenna ports. For example, LTE downlink transmission according to 3GPP (Third Generation Partnership Project) Releases 8 to 11 employs technology in which a plurality of transmission antenna ports are arranged in a lateral direction in a base station such that the azimuth (the angle within a horizontal plane) of a beam is controlled. The base station can control the direction of a transmission signal beam by adjusting the phase and the amplitude of the transmission signal with a beam forming matrix (a precoding matrix).

Also, for the standardization of 3GPP Release 13, there are plans to study technology (3D MIMO (three-dimensional MIMO)) for controlling the direction of a beam in terms of a vertical direction (i.e. the angle of depression and the angle of elevation) in addition to a horizontal direction, by arranging a plurality of transmission antenna ports two dimensionally, i.e., in longitudinal and lateral directions, in a base station. The base station can control the three-dimensional direction of a transmission signal beam by adjusting the phase and the amplitude of the transmission signal with a beam forming matrix (precoding matrix). The adjustment of a transmission signal performed for controlling the direction of a beam is referred to as beam forming or precoding.

In standardization, types of MIMO using a large number of antennas are classified into elevation beam forming and FD-MIMO (full dimension MIMO).

Elevation beam forming is technology in which a plurality of transmission antenna ports are arranged two dimensionally, i.e., in longitudinal and lateral directions, in a base station, and the direction of the beam is controlled in terms of a horizontal direction and a vertical direction. In standardization, elevation beam forming often means a type of 3D MIMO that uses eight or less transmission antenna ports.

FD-MIMO is technology for dramatically improving frequency usage efficiency by using numerous antenna elements in a base station to form an extremely sharply pointed beam (i.e., a beam having a high degree of directivity). With FD-MIMO, the transmission antenna ports are not necessarily arranged two dimensionally, and when the transmission antenna ports are arranged one dimensionally, for example, either the azimuth or the vertical direction of a beam is controlled (in this respect, FD-MIMO includes types of MIMO other than 3D MIMO. Alternatively, the transmission antenna ports may be three-dimensionally arranged, such as in a circular column shape or a cuboid shape. However, as with elevation beam forming, if the transmission antenna ports are two-dimensionally arranged in the base station, it is possible to easily control the direction of a beam in terms of a horizontal direction and a vertical direction. In standardization, FD-MIMO often means a type of MIMO that uses more than eight transmission antenna ports. The number of transmission antenna ports in a base station is, for example, 16 or more, and may be several hundreds, several thousands, or several tens of thousands. Apart from the standardization, FD-MIMO is often referred to as Massive MIMO or Higher-order MIMO. Patent Document 1 discloses Massive MIMO. It is of note that the definitions of elevation beam forming and FD-MIMO may change in the future.

With MIMO, it is possible to control the phase and the amplitude for each transmission antenna, and therefore the flexibility in controlling beams increases as the number of transmission antennas to be used increases. With 3D MIMO, a radio transmitting station forms transmission beams, each being directed to a corresponding one of radio receiving stations, and transmits, on the transmission beams, data signals that are addressed to the respective radio receiving stations, such that the radio receiving stations can respectively receive the transmission beams.

The LTE communication system uses a PSS (Primary Synchronization Signal) and an SSS (Secondary Synchronization Signal) in order for a UE (a user equipment or a mobile station) to synchronize with a network. The PSS and the SSS are used to allow the UE to be in synchronization with the system in terms of time and frequency, and to allow the UE to learn a physical cell ID, a cyclic prefix (CP), and information regarding whether the system is of the FDD type or the TDD type. The UE detects the PSS, thereby to learn the relative offset positions of the PSS and the SSS, and the physical cell ID. The UE detects the SSS, thereby to learn the frame timing and the cell ID group.

The PSS and the SSS are periodically transmitted twice within each radio frame of 10 ms. In an FDD system, the PSS is mapped to the last OFDM symbols in the first and the 11^{th} slots of each radio frame, and the SSS is mapped to the OFDM symbols immediately before the PSS. In a TDD system, the PSS is mapped in the third and the 13^{th} slots, and the SSS is mapped in three symbols earlier. The PSS and SSS are transmitted by using center six RBs that are fixed relative to the system bandwidth. The PSS and the SSS each are a sequence having a length of 62 symbols, and are mapped to 62 subcarriers either side of a DC subcarrier that is not used for data communication.

Examples of reference signals (RS) defined in 3GPP include cell-specific RS (CRS), channel state information RS (CSI-RS), and demodulation RS (DM-RS). Demodulation RS is also referred to as UE-specific RS.

In a communication system according to LTE (Release 8), it is essential to use a cell-specific RS (CRS). The cell-specific RS is supported with a use of, at the maximum, four transmission antennas of a base station (a cell) (see FIG. 6.1.0.1.2.1 of 3GPP TS 36,211). According to Release 8, the cell-specific RS is used for determining CSI (channel state information), demodulating data, measuring the reception quality (RSRP (Reference Signal Received Power), or RSRQ (Reference Signal Received Quality)) of signals from the cell, and demodulating a control channel (dedicated physical control channel, PDCCH). Data symbols included in the CRS may be used as an RSSI (Received Signal Strength Indicator) or for the measurement of a path loss. In order to measure RSRP or RSRQ, a UE generally samples the CRS during a given period of time and filters the sampled data.

The CRS symbols of each transmission antenna port are mapped to resource elements in a regular pattern. The CRS on different transmission antenna ports are transmitted at different time periods and at different frequencies. In other words, the CRS on different transmission antenna ports are orthogonally multiplexed with TDM and FDM.

According to LTE-Advanced (Release 10 or later), the channel state information RS (CSI-RS) and the demodulation RS (DM-RS) are used. The channel state information RS supports, at the maximum, eight transmission antennas of a base station (a cell).

The demodulation RS supports, at the maximum, eight transmission streams that can be transmitted from a base station (a cell). The demodulation RS is used for demodulating data signals specific to the mobile communication terminal (UE). The demodulation RS has been precoded in the same manner as that for data signals, and therefore the UE can demodulate the data signals by using the demodulation RS without using precoding information. Since the DM-RS and the CSI-RS are defined in LTE-Advanced, the importance of the CRS may decrease in the future.

The 3D MIMO transmission may use reference signals, such as CSI-RS, for channel state information estimation to determine precoding information in some cases, and the CSI-RS need not necessarily have been precoded as in Release 10, or may have been precoded. Specifically, it is possible to determine precoding information based on one or more CSI-RSs that have been transmitted by a base station and to which precoding has been applied.

### RELATED ART DOCUMENT

### Patent Document

Patent Document 1: Japanese Patent Application Laid-Open Publication No. 2013-232741

### SUMMARY OF THE INVENTION

### Problem to be Solved by the Invention

With 3D MIMO, a downlink data signal beam from a base station is controlled by using a precoding matrix. However, if precoding has not been applied to reference signals (such as CRSs or CSI-RSs) used by a user equipment for measuring the state of the transmission path or the reception quality, or if the precoding applied to the reference signals is different from that applied to data signals, the user equipment cannot measure the reception qualities in the directions corresponding to the data signals, with a high degree of accuracy. Consequently, even when the network receives a report on the reception quality from the user equipment, the network cannot select a serving base station suitable for the user equipment, or cannot estimate a direction of the beam suitable for the user equipment or link adaptive control, such as adaptive modulation coding.

Considering the above problems, the present invention provides a base station, a user equipment, and a radio communication network that allow for appropriate selection of a serving base station for a user equipment, tri and estimation of a direction of a beam suitable for the user equipment, in a manner that is adaptable to 3D MIMO.

### Means of Solving the Problems

A base station according to one aspect of the present invention includes: a plurality of transmission antenna ports; a precoding weight generator configured to generate precoding weights for controlling directions of beams to be transmitted on at least one of the transmission antenna ports; and a reference signal transmission controller configured to precode, with the precoding weights, a plurality of reference signals for measurements of reception qualities at a user equipment such that the plurality of reference signals are adapted respectively to a plurality of directions, and to transmit, on the at least one of the transmission antenna ports, the plurality of precoded reference signals in a format that allows the user equipment to distinguish between the plurality of reference signals.

A user equipment according to another aspect of the present invention includes: a reference signal receiver configured to receive a plurality of reference signals from one base station or each of a plurality of base stations in a network, the plurality of reference signals having been precoded, at each base station, using precoding weights for controlling directions of beams to be transmitted on a plurality of transmission antenna ports, and the plurality of reference signals being directed in a plurality of directions; a reception quality measurer configured to measure reception qualities of the plurality of reference signals; and an information reporter configured to report, to the network, information based on the reception qualities of the plurality of reference signals, wherein the information is used for at least one of selection of at least one serving base station, for the user equipment, in the network and estimation of a direction of a beam suitable for the user equipment. The information to be reported to the network by the information reporter may be information for link adaptive control such as adaptive modulation coding.

A radio communication network according to another aspect of the present invention includes a plurality of base stations and a serving base station determiner. Each base station includes: a plurality of transmission antenna ports; a precoding weight generator configured to generate precoding weights for controlling directions of beams to be transmitted on at least one of the transmission antenna ports; and a reference signal transmission controller configured to precode, with the precoding weights, a plurality of reference signals for measurements of reception qualities at a user equipment such that the plurality of reference signals are adapted respectively to a plurality of directions, and to transmit, on the at least one of the transmission antenna ports, the plurality of precoded reference signals in a format that allows the user equipment to distinguish between the plurality of reference signals, and the serving base station determiner is configured to determine at least one serving base station for the user equipment, based on results of measurements, at the user equipment, of reception qualities of the plurality of reference signals from the plurality of base stations.

### Effect of the Invention

According to the present invention, one or a plurality of precoded reference signals are transmitted from each base station, and a user equipment measures the reception quality or qualities of the reference signal(s), in a manner that is adaptable to 3D MIMO. Therefore, it is possible to appropriately select a serving base station for the user equipment, and to estimate a direction of a suitable beam for the user equipment.

### BRIEF DESCRIPTION OF THE DRAWINGS

FIG. 1 is a schematic diagram showing a base station according to the present invention.

FIG. 2 is a front view illustrative of an antenna set of the base station.

FIG. 3 is a front view illustrative of a modification of the antenna set.

FIG. 4 is a schematic diagram showing a base station of a comparative example.

FIG. 5 is a schematic diagram showing a base station of another comparative example.

FIG. 6 is a schematic diagram showing a radio communication network according to the present invention.

FIG. 7 is a diagram showing an example of mapping, to resource elements, of a plurality of CRSs that are transmitted from different transmission antenna ports of one base station.

FIG. 8 is a diagram showing complex weights given to the CRS symbols shown in FIG. 7.

FIG. 9A is a diagram showing an example of mapping, to resource elements, of a plurality of CRSs that are transmitted on one transmission antenna port of one base station.

FIG. 9B is a diagram showing another example of mapping, to resource elements, of a plurality of CRSs that are transmitted on one transmission antenna port of one base station.

FIG. 10 is a diagram showing complex weights given to the CRS symbols shown in FIG. 9B.

FIG. 11A is a diagram showing an example of mapping, to resource elements, of a plurality of CRSs that are transmitted on one transmission antenna port of one base station.

FIG. 11B is a diagram showing another example of mapping, to resource elements, of a plurality of CRSs that are transmitted on one transmission antenna port of one base station.

FIG. 12 is a diagram showing complex weights given to the CRS symbols shown in FIG. 11A.

FIG. 13 is a diagram showing an example of mapping, to resource elements, of a plurality of CRSs that are transmitted on two transmission antenna ports of one base station.

FIG. 14 is a diagram showing complex weights given to the CRS symbols shown in FIG. 13.

FIG. 15 is a diagram showing an example of mapping, to resource elements, of a plurality of CRSs that are transmitted on two transmission antenna ports of one base station.

FIG. 16 is a diagram showing another example of mapping, to resource elements, of a plurality of CRSs that are transmitted on two transmission antenna ports of one base station.

FIG. 17 is a diagram showing complex weights given to the CRS symbols shown in FIG. 16.

FIG. 18 is a sequence diagram showing a processing flow according to an embodiment when a UE is in an idle state (RRC_IDLE).

FIG. 19 is a sequence diagram showing a processing flow according to an embodiment when a UE is in a connected state (RRC_CONNECTED).

FIG. 20 is a sequence diagram showing a CSI feedback processing flow based on the CRSs according to an embodiment.

FIG. 21 is a diagram showing an example of allocation, to different antenna elements, of a plurality of pairs of a PSS and a SSS that are transmitted from one transmission antenna port of one base station.

FIG. 22 is a diagram showing an example of allocation, to different antenna elements, of a plurality of pairs of a PSS and a SSS that are transmitted from one transmission antenna port of one base station.

FIG. 23 is a sequence diagram showing a processing flow performed by a user equipment to synchronize with a base station according to an embodiment.

FIG. 24 is a block diagram showing a configuration of a base station according to an embodiment.

FIG. 25 is a block diagram showing a configuration of a user equipment according to an embodiment.

### MODES FOR CARRYING OUT THE INVENTION

In the following, description will be given of various embodiments of the present invention with reference to the attached drawings.

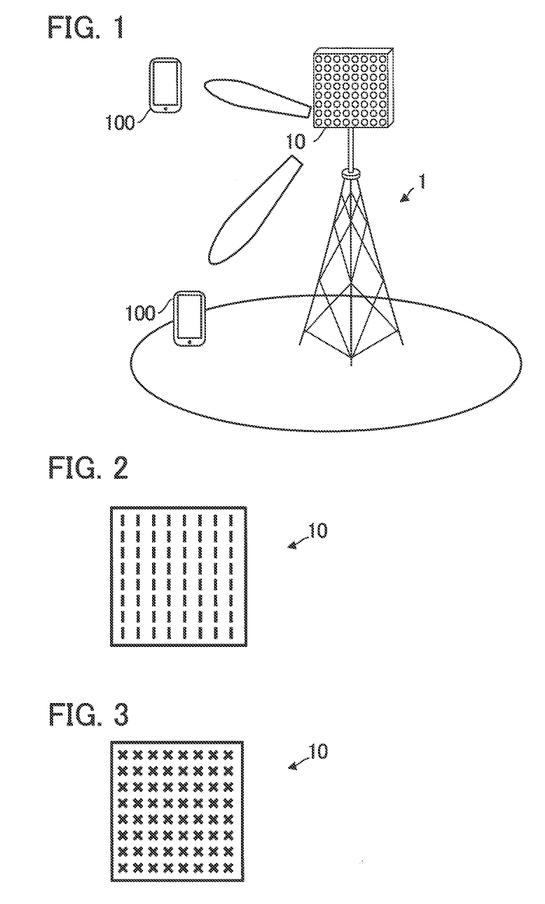

As shown in FIG. 1, a base station 1 according to the present invention has an antenna set 10 for 3D MIMO. In the antenna set 10, antenna elements are arranged two dimensionally, i.e., in longitudinal and lateral directions, or three dimensionally. Therefore, the base station 1 controls the direction of a beam in a vertical direction (i.e., the angle of depression and the angle of elevation) in addition to a horizontal direction (an azimuth direction) by adjusting the phase and the amplitude of a transmission signal with a beam forming matrix (a preceding matrix). The antenna set 10 is not necessarily arranged two or three dimensionally, and may be one-dimensionally arranged in an array in a horizontal or vertical direction.

Using such an antenna set 10, it is possible to form a beam in either the horizontal direction or the vertical direction or in the both directions. In other words, the range of possibilities in the adaptive beam control is expanded in either the horizontal direction or the vertical direction or in the both directions. The base station 1 can direct a downlink data signal beam towards a UE 100 that is located obliquely below, and the base station 1 can also direct the downlink data signal beam to a UE 100 that is located obliquely above. Also, the reception qualities of data signals (e.g., SINR (signal-to-interference-plus-noise ratio)) are improved at the UE 100, which is the destination of the beam. It is also possible to reduce interference to a UE that is in a neighbouring cell.

In the antenna set 10, the number of antenna elements in the longitudinal direction may be the same as or different from the number of antenna elements in the lateral direction. The antenna elements in the antenna set 10 may have the same, single polarization characteristics as shown in FIG. 2, or may be dual-polarized antenna elements as shown in FIG. 3. One single-polarized antenna element may be used as one transmission antenna port (one transmission antenna port being a transmission unit for reference signals described below). In the example shown in FIG. 2, 64 single-polarized antenna elements can be used as 64 transmission antenna ports. An antenna element that is orthogonally-polarized can be used as two transmission antenna ports. In the example shown in FIG. 3, 64 orthogonally-polarized antenna elements can be used as 128 transmission antenna ports.

Alternatively, a plurality of antenna elements (single-polarized elements or orthogonally-polarized elements) may be used as one transmission antenna port. For example, in the example shown in FIG. 3, four orthogonally-polarized antenna elements may be used as one transmission antenna port, and 64 orthogonally-polarized antenna elements may be used as 16 transmission antenna ports.

In such a 3D MIMO environment, a UE must appropriately select at least one serving base station (or a plurality of coordinated base stations for downlink CoMP) out of a large number of base stations that can transmit data signal beams in various directions, and this should be done for improving system performance. The downlink CoMP (Coordinated Multipoint Transmission) is technology in which multiple base stations coordinate with one another to perform data communication with one UE. CoMP includes: technology of, while one base station transmits data signals to one UE, another base station stopping downstream transmission such that this another base station does not interfere with the UE; technology of, while one base station transmits data signals to one UE, another base station controlling the beam direction such that this another base station does not interfere with the UE; and technology in which a plurality of base stations alternatingly transmit data signals to one UE.

With the directions of downlink data signal beams being controlled with 3D MIMO, but then reference signals for measuring reception qualities at a UE are directed in directions that are different from the directions of the data signals, the UE cannot measure the reception quality in the direction corresponding to the data signals. Therefore, even if the network receives a report from the UE on the reception quality, the network cannot select a suitable serving base station for the UE, or estimate a direction of the suitable beam. It is of note that, although examples of using the CRS are given here for selecting a serving base station, for estimating a suitable beam direction, and for performing the link adaptive control, the CSI-RS, or Discovery signals, or any other reference signals, or synchronization signals, such as PSS/SSS, may be used.

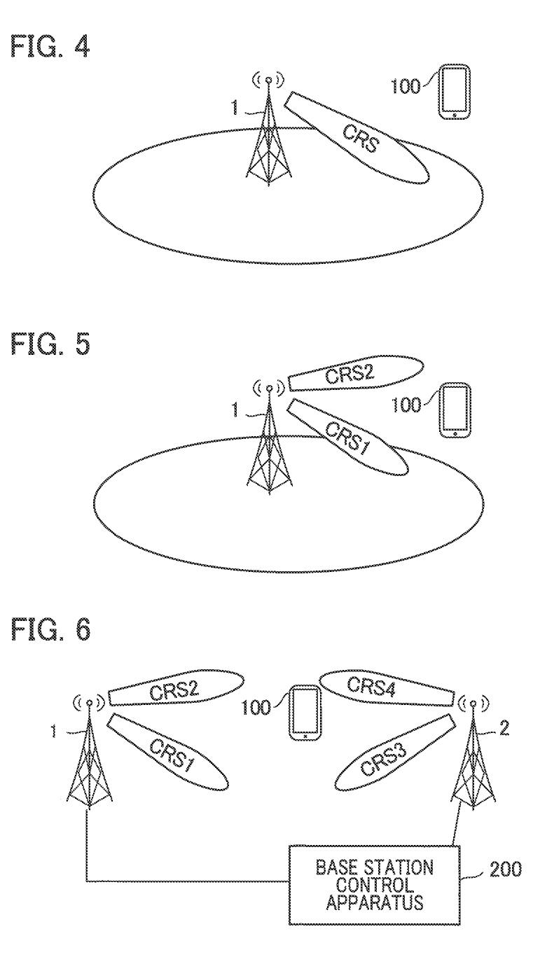

For example, in a case where the direction of the CRS beam is limited to a predetermined single direction with a depression angle as shown in FIG. 4, it is easy to form the CRS beam. However, since the direction of the data signal beam to be directed to the UE 100 located above is different from the direction of the CRS beam, the UE 100 cannot measure the reception quality in the direction corresponding to the data signal, and one possibility is that the UE 100 may be unable to connect the cell in the first place (or may miss an opportunity to connect to a neighbouring 3D MIMO cell that is better in the reception quality). Also, if the CRS beam is wide in width and the reaching distance thereof is short, the coverage distance of the base station 1 decreases due to the small beam forming gain, and if the beam is narrow in width, the coverage angle of the base station 1 decreases.

Therefore, it is preferable that a plurality of CRSs are transmitted from the base station in a plurality of directions. FIG. 5 shows the base station 1 transmitting different CRSs (CRS1 and CRS2) in a plurality of directions. The CRS1 and the CRS2 have been precoded using different precoding matrices. It is possible to give a cell ID to each CRS beam, assuming that each CRS beam is one cell. If this is the case, it would be possible to use the existing mapping pattern for CRS resource elements without significantly changing the specification of the existing 3GPP standard. However, if a cell ID is given to each CRS beam, the UE regards the plurality of CRS beams as different cells. Therefore, if the UE selects any of the beams as a beam in a favorable direction, inter-cell handover, which involves a large number of processes, will be required.

Accordingly, in embodiments of the present invention, each base station transmits CRSs in a format that allows a UE to distinguish between a plurality of precoded CRSs. Each base station, as a cell, transmits a plurality of precoded CRSs in the form of beams. The UE 100 can measure the reception qualities of the CRSs that are transmitted from each base station using a plurality of beams. Based on a measurement result of the reception quality performed at the UE 100, a serving base station or a plurality of coordinated base stations for CoMP are appropriately selected. For example, it is possible to select a base station that has transmitted a CRS beam having the best reception quality, as a serving base station. In this case as well, it is possible to use the existing mapping pattern for CRS resource elements without significantly changing the specification of the exiting 3GPP standard.

Specifically in a case where the base station 1 transmits a beam of CRS1 and a beam of CRS2 and a base station 2 transmits a beam of CRS3 and a beam of CRS4 as shown in FIG. 6, if the RSRP of CRS4 is the highest among the measured RSRPs of the CRSs, the base station 2 is selected as the serving base station for the UE 100. The number of CRS beams transmitted from each base station is not limited to two, and may be three or more, or may be several hundreds, for example.

If the best beam for the UE 100 from among the CRS beams transmitted from a plurality of base stations can be found out (e.g., if the RSRP of CRS4 can be found as the highest), the serving base station is able to learn an approximate direction of the beam that is suitable for the UE 100 based on a report from the UE 100 on information regarding a beam suitable for the UE 100. The serving base station can also determine or correct the precoding matrix for data signals based on the information regarding the direction of the beam suitable for the UE 100. The base station may determine the precoding matrix for data signals by using information regarding a result of CRS cell selection at the UE 100. For example, in the case of using a result of CSI-RS measurement to determine the precoding matrix for data signals, the precoding matrix may be corrected based on a result of CRS measurement. Therefore, each base station may precode a plurality of CSI-RSs using different precoding matrices.

The UE 100 and the base station may perform beam determination, or precoding matrix determination or correction, step by step. For example, the UE 100 may first select four best beams out of several hundreds of reference signal beams, to select the best beam out of the four beams. Alternatively, the base station may first emit a plurality of reference signal beams limited to those in one of the horizontal direction or the vertical direction only (e.g., only the horizontal direction), such that the UE 100 selects the best beam (e.g., the best horizontal beam) therefrom; the base station may next emit, within the plane of the direction selected by the UE 100, a plurality of beams limited to those in the other direction (e.g., the vertical direction), such that the UE 100 selects the best beam therefrom. Alternatively, the base station may first emit a plurality of CRS beams (roughly directed beams), such that the UE 100 selects the best beam therefrom; the base station may next emit a plurality of CSI-RS beams in directions that approximate the rough directions selected by the UE 100, and the UE 100 may select the best beam therefrom. The serving base station may determine a precoding matrix based on information regarding the best beam ultimately selected by the UE 100.

In the following description, the CRS will be mainly described as an example of reference signals to be precoded. However, the reference signals to be precoded may be other reference signals, such as the CSI-RS or the Discovery RS, synchronization signals such as the PSS or the SSS, or the like, and the CRS in the following description is interchangeable with these reference signals, synchronization signals, or the like.

As described above, each base station transmits a plurality of precoded CRSs in beams in a format that allows the UE to distinguish between the plurality of precoded CRSs. A plurality of CRSs can be distinguished from one another based on time, frequency, code, space, a transmission antenna port, or a combination thereof. For example, it is convenient to map a plurality of CRSs to different resource elements each being defined based on frequency and time. The precoding matrix used for precoding is constituted by complex weights. The existing rules (including CRS sequence generation, demodulation, a CRS mapping pattern, frequency shifting, electrical power boosting, resource element allocation, and so on) can be used to generate CRSs.

In order to allow the UE to distinguish the CRS transmitted from the base station, each base station notifies the UE of information indicating a method employed to transmit a plurality of CRSs. Preferably, this information is broadcast by the base stations. This information includes at least the number of CRSs, IDs of the respective CRSs, and resource elements and transmission antenna ports allocated to the respective CRSs (which may be in the form of formulas or tables). When the spread code and the space are used for the identifying the CRS, the spread code and space are also indicated by this information. Rules, such as mapping of the CRS to resource elements (e.g., the relationship between the IDs of the CRSs and the resource elements to which the CRSs are allocated), may be defined in the specification of the standard, and in this case, the information indicating a method employed to transmit the plurality of CRSs may include only the IDs of the respective CRSs.

Information indicating a method employed to transmit a plurality of CRSs should be provided to the UE. The information indicating a method employed to transmit the plurality of CRSs may be broadcast to the UE that is in the idle state (RRC_IDLE) or in the connected state (RRC_CONNECTED), using a system information block (SIB) that is transmitted via a broadcast channel (BCH) for selecting or re-selecting a cell. Alternatively, this information may be provided to the UE through RRC signaling. For example, this information may be added to an RRC Connection Reconfiguration message used for handover for a UE that is in the connected state (RRC_CONNECTED).

Based on the information indicating a method employed to transmit the plurality of CRSs from the base station, the UE learns the number of the CRSs to be transmitted from the base station, the IDs of the CRSs, the resource elements to which the CRSs have been mapped, and the number of transmission antenna ports on which the CRSs are transmitted. Thus, the UE can distinguish between a plurality of precoded CRSs.

Using the precoded CRSs, the UE measures the reception quality of each CRS. The reception quality may be RSRP, RSRQ, an RSSI, a path loss, or an SINR. The UE may measure the reception quality periodically or triggered by a certain event.

The UE reports, to the network, information that directly indicates measurement results of the reception qualities of the CRSs, or information that is based on the measurement results. This report may be periodically provided, or may be triggered by a particular event (e.g., any of EVENTS A1 to A5 defined in 3GPP TS 36.331). The destination of the report may be the current serving base station for the UE or a base station control apparatus 200 (see FIG. 6) that controls a plurality of base stations. The information to be reported is all or some of: information on the selection of at least one serving base station, for the UE, in the network; information for estimating a direction of a beam suitable for the UE; and information for link adaptive control.

For example, the UE may report a CRS ID corresponding to a beam that has the best reception quality for the UE out of CRS beams transmitted from a plurality of base stations. For example, a CRS ID corresponding to the highest RSRP or RSRQ may be reported. Furthermore, the value of the best reception quality measured by the UE may be reported.

Alternatively, the UE may report CRS IDs corresponding to some CRS beams that have good reception qualities out of the CRS beams transmitted from a plurality of base stations, and the cell IDs of the base stations having transmitted the CRSs. Furthermore, the values of the good reception qualities measured by the UE may be reported.

Alternatively, the UE may report the reception qualities of all of the CRS beams transmitted from a plurality of base stations. If this is the case, each reception quality may be reported in a format that associates a CRS ID and a cell ID that are in pairs. Alternatively, if the relationship between the order of reports on the reception qualities and different pairs of the CRS ID and the cell ID are known in the network, the UE does not have to report the CRS IDs or the cell IDs of the base stations having transmitted the CRSs.

Based on the above-described report from the UE, the current serving base station for the UE or the base station control apparatus 200 determines the next serving base station (which may be a plurality of coordinated base stations for downlink CoMP) for the UE. In this regard, the current serving base station may be provided with a serving base station determiner, or the base station control apparatus 200 may serve as the serving base station determiner. The determination of such a serving base station may be a cell selection, a cell re-selection, or a handover. In a case where the current serving base station determines the next serving base station, each base station is provided with functions of the base station control apparatus.

For example, the current serving base station or the base station control apparatus 200 may determine, as the next serving base station, a base station that has transmitted a CRS beam that has the best reception quality (e.g., RSRP or RSRQ) for the UE, or a base station that has transmitted a CRS beam that has a reception quality greater than a threshold value (e.g., the reception quality provided by the current serving base station).

If the base station, which has transmitted a CRS beam of the best reception quality for the UE, is the current serving base station, the current serving base station will be the next serving base station. Therefore, if this is the case, none of selection nor re-selection of a cell, nor handover is performed, and it is therefore not necessary to perform processing required therefore.

Also, based on the report from the UE, the next serving base station or the base station control apparatus 200 can estimate a direction of a suitable beam from the next serving base station to the UE. As described above, the serving base station can also determine or correct the precoding matrix for the data signal based on the direction of the suitable beam for the UE 100.

Furthermore, the UE may determine CSI based on the reception qualities (e.g., SINR) of a plurality of beams of precoded CRS beams or on the best reception quality, and may feedback (report) to the serving base station or to the base station control apparatus 200 on the determined CSI. Types of CSI include a Rank Indicator (RI), a Precoding Matrix Indicator (PMI), and a Channel Quality Indicator (CQI). Beams used for determining CSI are not limited to CRS beams for the matter of course, and may be CSI-RS beams. The CSI may be reported at the same time as the measurement results of reception qualities are reported, or may be reported at a different point in time.

The UE receives a plurality of CRS beams from the serving base station, and measures the reception qualities of the CRS beams. Preferably, the UE may select, based on the best reception quality among the reception qualities of the CRS beams, an RI and a PMI that correspond to a beam that has the best reception quality, calculate a CQI that corresponds to the beam of the best reception quality, and report CSI that corresponds to the beam of the best reception quality. The serving base station uses a rank number and a precoding matrix that correspond to the RI and the PMI that have been fed back thereto, to perform frequency scheduling based on the CQI that has been fed back thereto. A CRS ID that corresponds to the beam of the best reception quality and/or the cell ID of a base station that has transmitted that CRS may be reported together with the CSI when the CSI is reported.

Alternatively, the UE may select a plurality of RIs and a plurality of PMIs that correspond to some of the plurality of beams having good reception qualities from among CRS beams transmitted from the serving base station, calculate a plurality of CQIs corresponding to the some of the plurality of beams, and report the CSI corresponding to the some beams of good reception qualities. CRS IDs that correspond to the beams of good reception qualities may be reported together with the CSI when the CSI is reported. The serving base station determines, based on the CSI that has been fed hack thereto, a rank number, a precoding matrix, and a CQI to be used, uses the determined rank number and precoding matrix, which correspond to the RI and the PMI, and performs frequency scheduling based on the determined CQI.

Alternatively, the UE may select a plurality of RIs and a plurality of PMIs corresponding to all of the CRS beams transmitted from the serving base station, calculate a plurality of CQIs corresponding to all of the CRS beams, and report pieces of CSI corresponding to a plurality of or all of the CRS beams. If this is the case, the UE may perform a reporting in a format in which each CSI is associated with a corresponding CRS ID. Alternatively, if the relationship between the reporting order of the CSI pieces and the different pairs of a CRS ID and a cell ID are known in the network, the UE does not have to report the CRS IDs. The serving base station determines, based on the CSI that has been fed back thereto, a rank number, a precoding matrix, and a CQI to be used, uses the determined rank number and precoding matrix, which correspond to the RI and the PMI, and performs frequency scheduling based on the determined CQI.

Next, description will be given as to how the embodiment of the present invention affects the specification of the standard.

A format that allows the UE to distinguish between a plurality of precoded CRSs and information indicating a method employed to transmit the CRSs should be defined in the specification of the standard. The information indicating a method employed to transmit the CRSs may include at least the number of the CRSs transmitted from a base station, IDs used for the generation and the mapping of the CRSs, and resource elements and the number of transmission antenna ports allocated to the CRSs (which may be in the form of formulas or tables). The IDs may be the cell IDs defined in Release 8. or virtual cell IDs.

A method for broadcasting the information (e.g., CRS IDs) indicating a method employed to transmit a plurality of CRSs should be defined in the specification of the standard. Such information should be notified to a UE such that the UE can distinguish between CRSs that have been mapped to the resource elements, measure the reception quality of each CRS, and report the reception qualities with the corresponding CRSs being associated thereto. The information may be broadcast to a UE that is in the idle state (RRC_IDLE) or in the connected state (RRC_CONNECTED), using a system information block (SIB) that is transmitted via a broadcast channel (BCH) for selecting or re-selecting a cell. Alternatively, this information may be provided to the UE through RRC signaling. For example, this information may be added to an RRC Connection Reconfiguration message used for handover for the UE that is in the connected state (RRC_CONNECTED).

The reception quality measurement and reporting for handover that are performed by the UE should be defined in the specification of the standard. The UE should measure the reception qualities of CRS beams that have been notified using SIB or through RRC signaling, instead of the reception qualities of all of the CRS beams that can be measured.

A reception quality that is reported, the reporting being triggered by a particular event (e.g., any of EVENTs A1 to A5 defined in 3GPP TS 36.331), is a reception quality of a CRS beam that has the best reception quality for the UE, or a combination of a reception quality of a CRS beam received from the serving base station with the best reception quality for the UE and a reception quality of a CRS beam received from a neighbouring base station with the best reception quality for the UE. The CRS ID corresponding to the CRS beam having the best reception quality may be or may not be reported.

A reception quality to be periodically reported is a reception quality of a CRS beam that has the best reception quality for the UE, or the reception qualities of a plurality of CRS beams from a base station (the serving base station and/or a neighbouring base station). The CRS IDs corresponding to the reception qualities may be or may not be reported.

In FIG. 6.10.1.2.1 of the current version of 3GPP TS 36.211, the base station uses, at the maximum, four transmission antenna ports to transmit the CRS. However, a definition should be added to the specification of the standard such that a larger number of CRS beams can be transmitted on a larger number of transmission antenna ports (or with a larger number of precoders).

The determination and feedback of CSI (RI, PMI, and CQI) based on the CRS should be defined in the specification of the standard. The UE may select an RI and a PMI that correspond to a CRS beam that has the best reception quality from the serving base station, calculate a CQI that corresponds to the CRS beam having the best reception quality, and report CSI that corresponds to the beam having the best reception quality. Alternatively, the UE may select a plurality of RIs and a plurality of PMIs that correspond to a plurality of CRS beams from the serving base station, calculate a plurality of CQIs that correspond to the plurality of CRS beams, and report pieces of CSI corresponding to the plurality of CRS beams. CRS IDs corresponding to the CSI pieces to be reported may be or may not be reported.

It is desirable to have the conventional UE, which does not perform reception quality measurement using a plurality of precoded-CRS beams, still operable in the system in which precoded-CRS beams are transmitted. The conventional UE does not decode information indicating a method employed to transmit a plurality of CRSs, and measures the reception qualities of the CRSs by using a conventional method as if the CRSs were not precoded or not transmitted on a plurality of beams. This is possible because the arrangement of resource elements to which the CRS is mapped and a sequence of the CRSs may be the same as those in the current LTE system or LTE-A system (see 3GPP TS 36.211).

In the following, description will be given of an example of the mapping, to resource elements, of a plurality of CRSs that are precoded and transmitted using different beams.

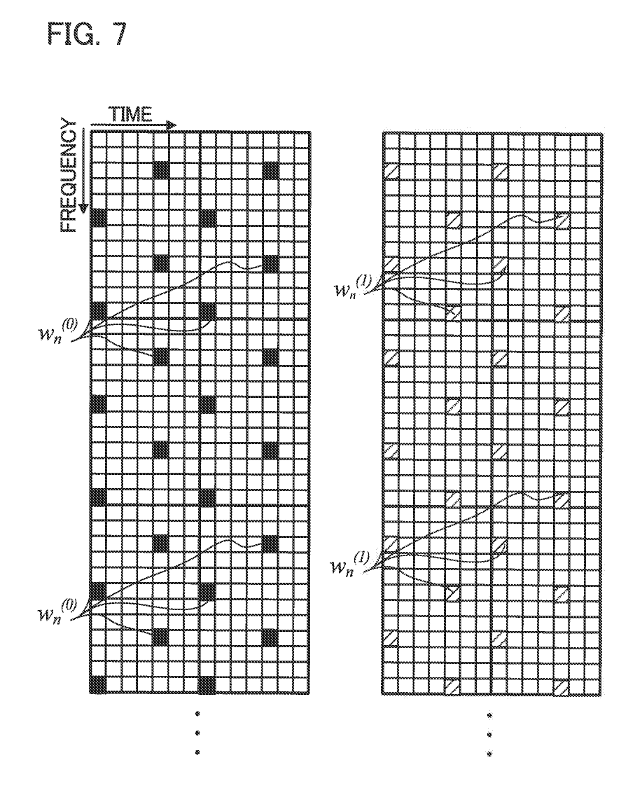

FIG. 7 is a diagram showing an example of the mapping, to resource elements, of a plurality of CRSs that are transmitted on different transmission antenna ports of one base station. In FIG. 7 and in the subsequent drawings, resource elements to which CRSs are mapped are colored. In FIGS. 7 to 14, different color patterns indicate different CRS beams (i.e., indicate that the CRSs have been precoded in different manners). Here, two types of resource elements are used, and two CRSs are transmitted on two beams 0 and 1. Here, in this example, the positions of the resource elements for the CRS beams are the same as those of antenna ports 0 and 1 in the current LTE specification. “i” (0 or 1 in the drawing) in wₙ⁽ⁱ⁾ is a beam index that indicates a CRS beam (which may be the same as the above-described CRS ID). The patterns of mapping, to the resource elements, of the two CRSs to be transmitted are different from each other. Therefore, the example in FIG. 7 shows a CRS mapping pattern at different transmission antenna ports.

In order to generate beam 0 for a CRS, the following precoding matrix (vector in this example) is used for the CRS.
W⁽⁰⁾
   In order to generate beam 1 for a CRS, the following precoding matrix (vector in this example) is used for the CRS.
W⁽¹⁾

The precoding vectors W⁽ⁱ⁾ can be expressed by the following formula.

$${W}^{( i )} = [ \begin{matrix}{w}_{0}^{( i )} \\ {w}_{I}^{( i )} \\ ⋮ \\ {w}_{N - I}^{( i )}\end{matrix} ]$$

Here, wₙ⁽ⁱ⁾ denotes a complex weight for the n^{th} transmission antenna of the transmission antenna port, and i denotes an index that indicates a CRS beam. N denotes the number of transmission antennas.

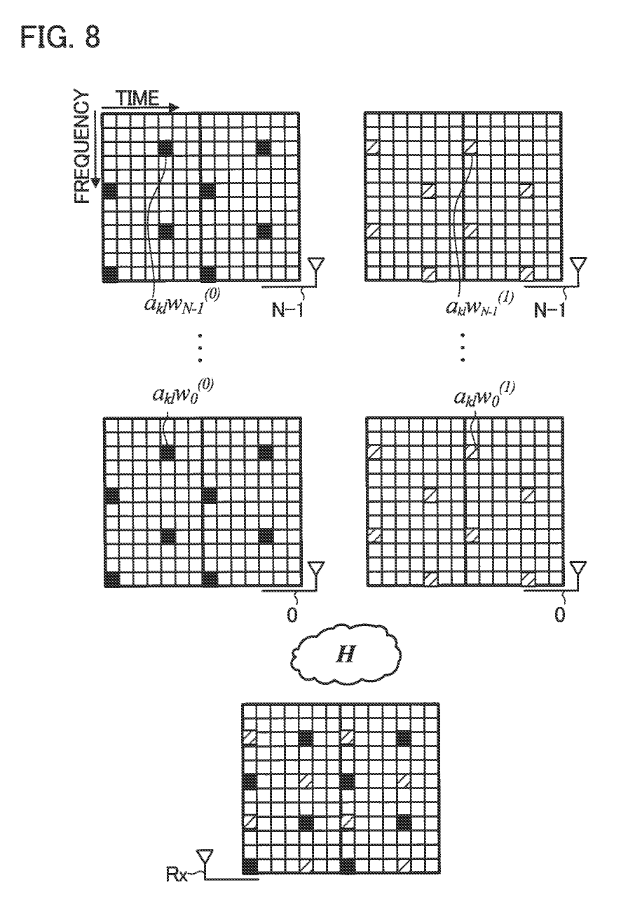

More specifically, as shown in FIG. 8, CRS symbol aₖₗ transmitted from antenna element 0 by using beam 0 is multiplied by complex weight w₀⁽⁰⁾. k denotes a frequency index of the resource element, and l denotes a time index of the resource element. CRS symbol aₖₗ transmitted from antenna element N-1 by using beam 0 is multiplied by complex weight w_{N-1}⁽⁰⁾. CRS symbol aₖₗ transmitted from antenna element 0 by using beam 1 is multiplied by complex weight w₀⁽¹⁾, and CRS symbol aₖₗ transmitted from antenna element N-1 by using beam 1 is multiplied by complex weight W_{N-1}⁽¹⁾.

In this way, two CRS beams transmitted from two transmission antenna ports are received by the reception antenna Rx of the UE via the transmission path indicated by H. The UE can measure the reception qualities of these two CRS beams.

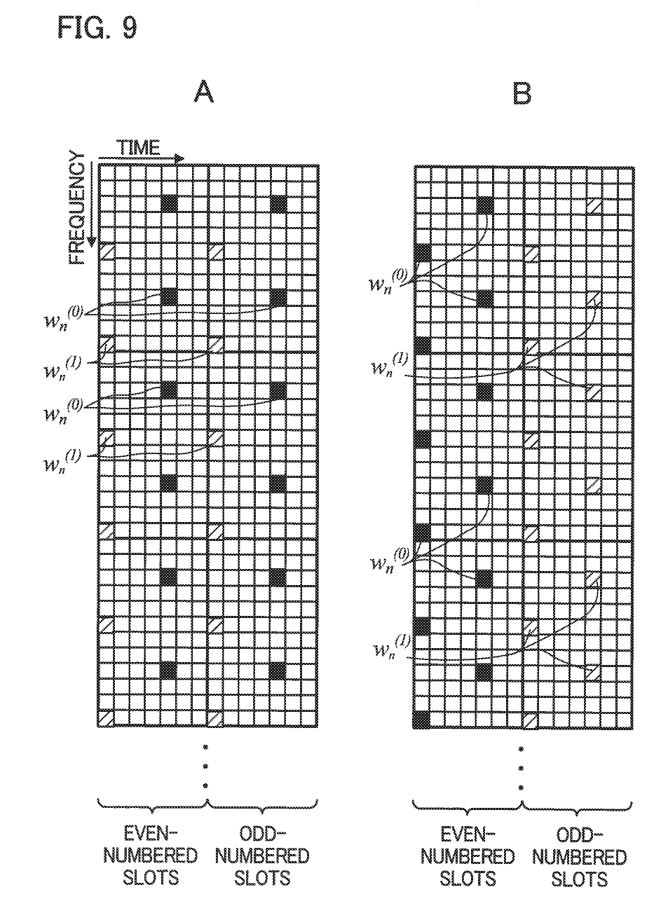

FIG. 9A shows an example of mapping, to resource elements, of a plurality of CRSs that are transmitted on one transmission antenna port of one base station. Here, the resource elements of antenna port 0 are used, and two types of CRSs are transmitted by using two beams 0 and 1. More specifically, out of the resource elements used for antenna port 0, the 0^{th} and the 7^{th} symbols are used for transmitting beam 1, and the fourth and the 11^{th} symbols are used for transmitting beam 0.

FIG. 9B shows another example of mapping, to resource elements, of a plurality of CRSs that are transmitted on one transmission antenna port of one base station. Here, the resource elements of antenna port 0 are used, and two types of CRSs are transmitted by using two beams 0 and 1. More specifically, out of the resource elements used for antenna port 0, the even-numbered slots are used for transmitting beam 0, and the odd-numbered slots are used for transmitting the beam 1.

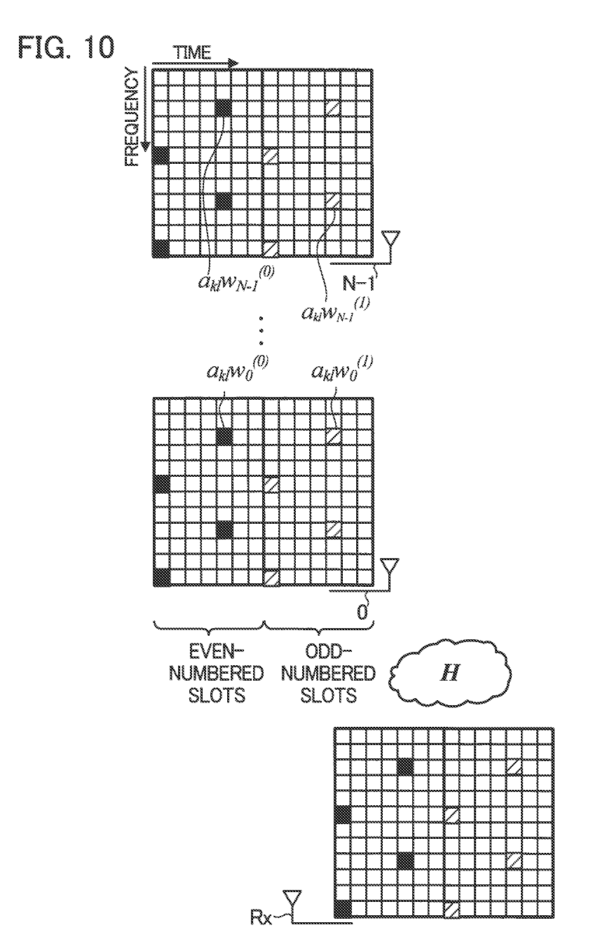

Regarding the mapping shown in FIG. 9B, more specifically, CRS symbol aₖₗ that is transmitted from antenna element 0 in an even-numbered time slot with beam 0 is multiplied by complex weight w₀⁽⁰⁾ as shown in FIG. 10. CRS symbol aₖₗ transmitted from antenna element N-1 in an even-numbered time slot with beam 0 is multiplied by complex weight w_{N-1}⁽⁰⁾. CRS symbol aₖₗ transmitted from antenna element 0 in an odd-numbered time slot with beam 1 is multiplied by complex weight w₀⁽¹⁾, and CRS symbol aₖₗ transmitted from antenna element N-1 in an odd-numbered time slot with beam 1 is multiplied by complex weight w_{N-1}⁽¹⁾.

In this way, two CRS beams transmitted from one transmission antenna port are received by the reception antenna Rx of the UE via the transmission path indicated by H. The UE can measure the reception qualities of these two CRS beams.

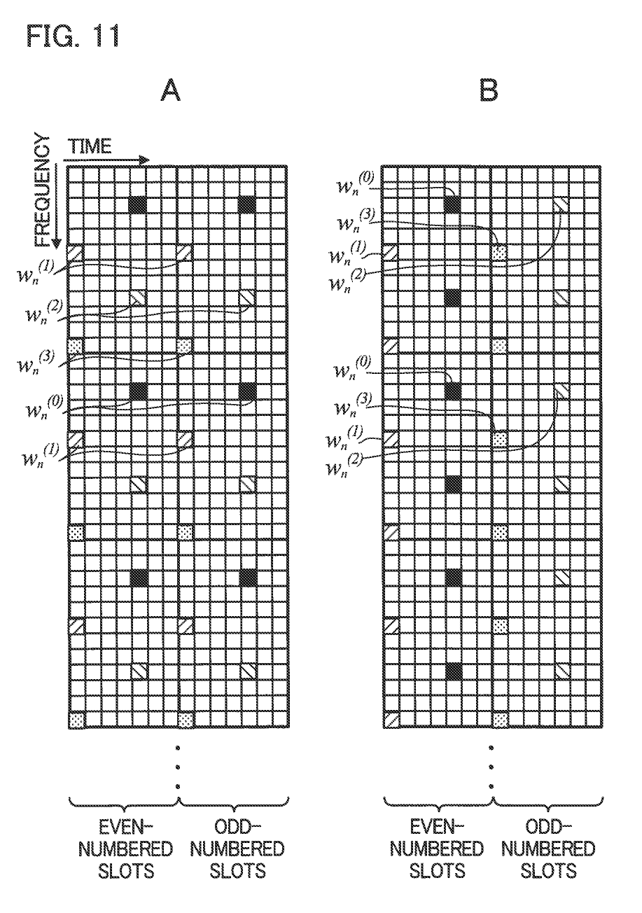

FIG. 11A shows an example of mapping, to resource elements, of a plurality of CRSs that are transmitted on one transmission antenna port of one base station. Here, the resource elements of transmission antenna port 0 for CRSs are used, and four CRS beams 0, 1, 2, and 3 are transmitted. More specifically, on one transmission antenna port, the four CRSs to be transmitted are mapped to different resource elements. Therefore, the example in FIG. 11A shows a time-frequency mapping pattern of the CRS. The CRS mapping pattern of the resource elements in even-numbered time slots is the same as that in odd-numbered time slots. The resource elements to which CRSs have been mapped are the same as those shown in FIG. 6.10.1.2.1 of 3GPP TS 36.211.

FIG 11B shows another example of mapping, to resource elements, of a plurality of CRS beams from one base station. Here, one transmission antenna port 0 is used, and four CRSs are transmitted by using four beams 0, 1, 2, and 3. More specifically, regarding one transmission antenna port, the four CRSs to be transmitted are mapped to different resource elements. Therefore, the example in FIG. 11B also shows a time-frequency mapping pattern of the CRS. However, a CRS mapped to resource elements at a given time period and a CRS mapped to resource elements at another time period are different (have been precoded in different manners). The resource elements to which CRSs have been mapped are the same as those shown in FIG. 6.10.1.2.1 of 3GPP TS 36.211.

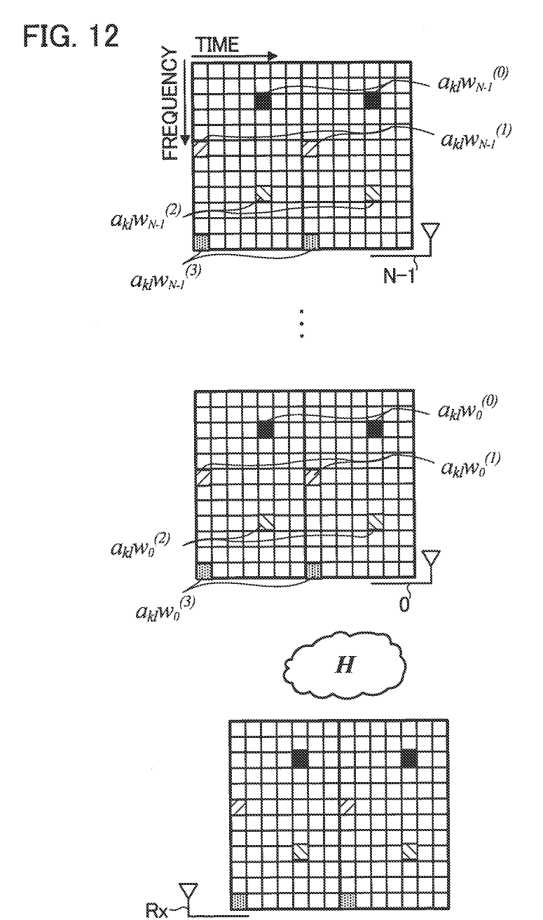

As for the mapping shown in FIG. 11A, more specifically, CRS symbol aₖₗ transmitted from antenna element 0 by using beam 0 is multiplied by complex weight w₀⁽⁰⁾ as shown in FIG. 12. CRS symbol aₖₗ transmitted from antenna element N-1 through beam 0 is multiplied by complex weight W_{N-1}⁽⁰⁾. CRS symbol aₖₗ transmitted from antenna element 0 by using beam 1 is multiplied by complex weight w₀⁽¹⁾, and CRS symbol aₖₗ transmitted from antenna element N-1 by using beam 1 is multiplied by complex weight w_{N-1}⁽¹⁾. CRS symbol aₖₗ transmitted from antenna element 0 by using beam 2 is multiplied by complex weight w₀⁽²⁾, and CRS symbol aₖₗ transmitted from antenna element N-1 by using beam 2 is multiplied by complex weight W_{N-1}⁽²⁾. CRS symbol aₖₗ transmitted from antenna element 0 by using beam 3 is multiplied by complex weight w₀⁽³⁾, and CRS symbol aₖₗ transmitted from antenna element N-1 by using beam 3 is multiplied by complex weight W_{N-1}⁽³⁾.

In this way, four CRS beams transmitted from one transmission antenna port are received by the reception antenna Rx of the UE via the transmission path indicated by H. The UE can measure the reception qualities of these four CRS beams.

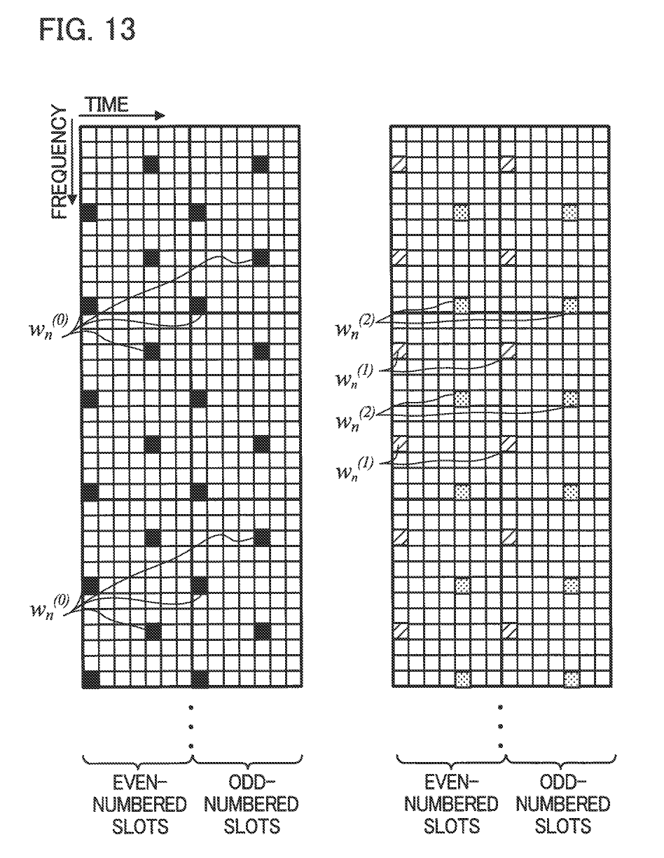

FIG. 13 shows an example of mapping, to resource elements, of a plurality of CRSs that are transmitted on two transmission antenna ports of one base station. Here, the resource elements of two transmission antenna ports 0 and 1 are used, and three CRSs are transmitted by using three beams 0, 1, and 2. More specifically, beam 0 for one CRS is transmitted on multiplexing positions of transmission antenna port 0, and beams 1 and 2 for two CRSs are transmitted on multiplexing positions of transmission antenna port 1 by using different resource elements for beams 1 and 2. Therefore, the example in FIG. 13 shows a time-frequency mapping pattern of the CRS for different transmission antenna ports. The resource elements to which CRSs have been mapped are the same as those shown in FIG. 6.10.1.2.1 of 3GPP TS 36.211. The two CRS beams 1 and 2 of the transmission antenna port 1 in even-numbered time slots and odd-numbered time slots are mapped according to the same pattern.

Since only one CRS beam is transmitted on the transmission antenna port 0, it is possible to apply this mapping pattern to MIMO according to the specification of the existing standard.

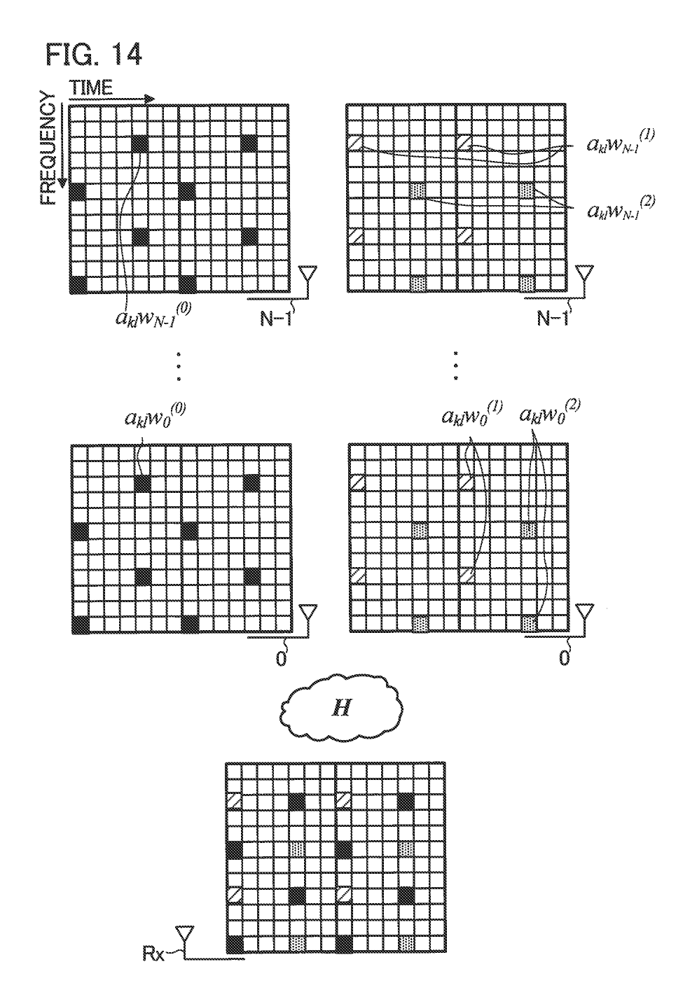

As for the mapping shown in FIG. 13, more specifically, CRS symbol aₖₗ transmitted from antenna element 0 by using beam 0 is multiplied by complex weight w₀⁽⁰⁾ as shown in FIG. 14. CRS symbol aₖₗ transmitted from antenna element N-1 by using beam 0 is multiplied by complex weight w_{N-1}⁽⁰⁾. CRS symbol aₖₗ transmitted from antenna element 0 by using beam 1 is multiplied by complex weight w₀⁽¹⁾, and CRS symbol aₖₗ transmitted from antenna element N-1 by using beam 1 is multiplied by complex weight w_{N-1}⁽¹⁾. CRS symbol aₖₗ transmitted from antenna element 0 by using beam 2 is multiplied by complex weight w₀⁽²⁾, and CRS symbol aₖₗ transmitted from antenna element N-1 by using beam 2 is multiplied by complex weight w_{N-1}⁽²⁾.

In this way, three CRS beams transmitted on the resource elements of two transmission antenna ports are received by the reception antenna Rx of the UE via the transmission path indicated by H. The UE can measure the reception qualities of these three CRS beams.

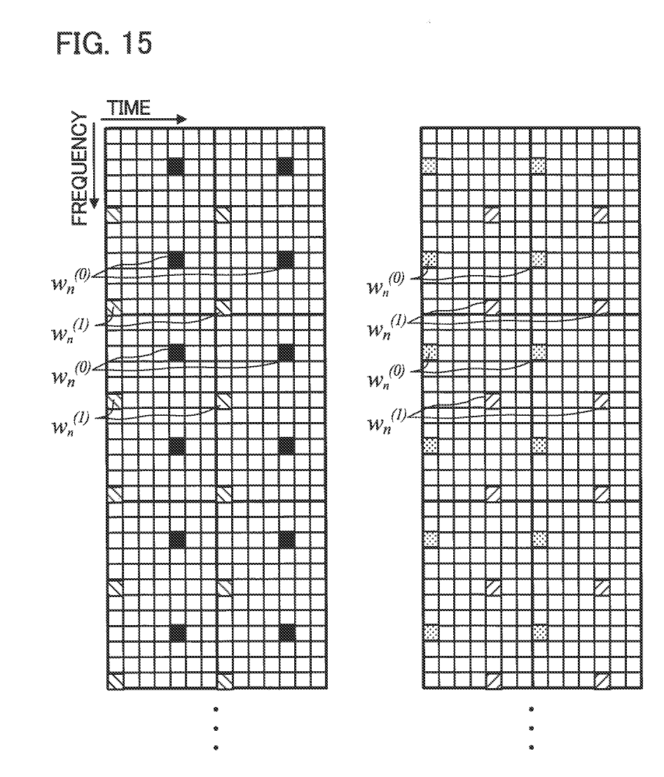

FIG. 15 shows an example of mapping, to resource elements, of a plurality of CRSs that are transmitted on two transmission antenna ports of one base station. In FIGS. 15 to 17, different color patterns indicate different ports and different CRS beams. Here, the resource elements of two transmission antenna ports are used, and two CRSs are transmitted by using two beams. More specifically, beams 0 and 1 for the two CRSs are transmitted on respective one of the two existing mapping resources. CRS beam 0 is mapped to resource elements at the same frequency and in different time periods in the resources of each of the antenna ports. Similarly, CRS beam 1 is mapped to resource elements at the same frequency and in different time periods in resources of each of the antenna ports. Therefore, the example in FIG. 15 shows a time-frequency mapping pattern of the CRS. The resource elements to which CRSs have been mapped are the same as those shown in FIG. 6.10.1.2.1 of 3GPP TS 36.211. This mapping pattern is suited for CRS-based CSI determination and reporting. The beams 0 and 1 for the two CRSs corresponding to the resource element positions of the transmission antenna port 0 are mapped according to the same pattern for even-numbered time slots and for odd-numbered time slots, and the beams 0 and 1 for the two CRSs corresponding to the resource element positions of the transmission antenna port 1 are mapped according to the same pattern for even-numbered time slots and for odd-numbered time slots.

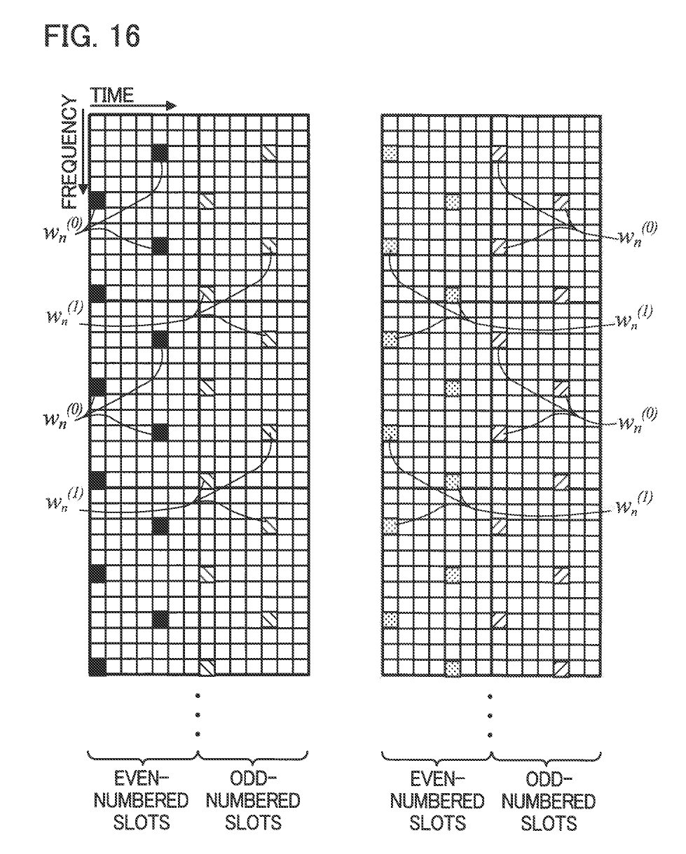

FIG. 16 shows another example of mapping, to resource elements, of a plurality of CRSs that are transmitted on two transmission antenna ports of one base station. Here, multiplexing positions of two transmission antenna ports are used, and two CRSs are transmitted by using two beams. More specifically, beams 0 and 1 for the two CRSs are transmitted on resource element positions of transmission antenna port 0, and beams 0 and 1 for the two CRSs are also transmitted on resource element positions of transmission antenna port 1. CRS beam 0 is mapped to resource elements at the same frequency and in different time periods in each of transmission antenna ports 0 and 1, and CRS beam 1 is mapped to resource elements at the same frequency and in different time periods in each of transmission antenna ports 0 and 1. Therefore, the example in FIG. 16 also shows a time-frequency mapping pattern of the CRS. The resource elements to which CRSs have been mapped are the same as those shown in FIG. 6.10.1.2.1 of 3GPP TS 36.211. This mapping pattern is suited for CRS-based CSI determination and reporting. CRS beam 0 from resource element positions of transmission antenna port 0 is arranged in even-numbered time slots, and CRS beam 1 from resource element positions of transmission antenna port 0 is arranged in odd-numbered time slots. CRS beam 0 from transmission antenna port 1 is arranged in odd-numbered time slots, and CRS beam 1 from transmission antenna port 1 is arranged in even-numbered time slots.

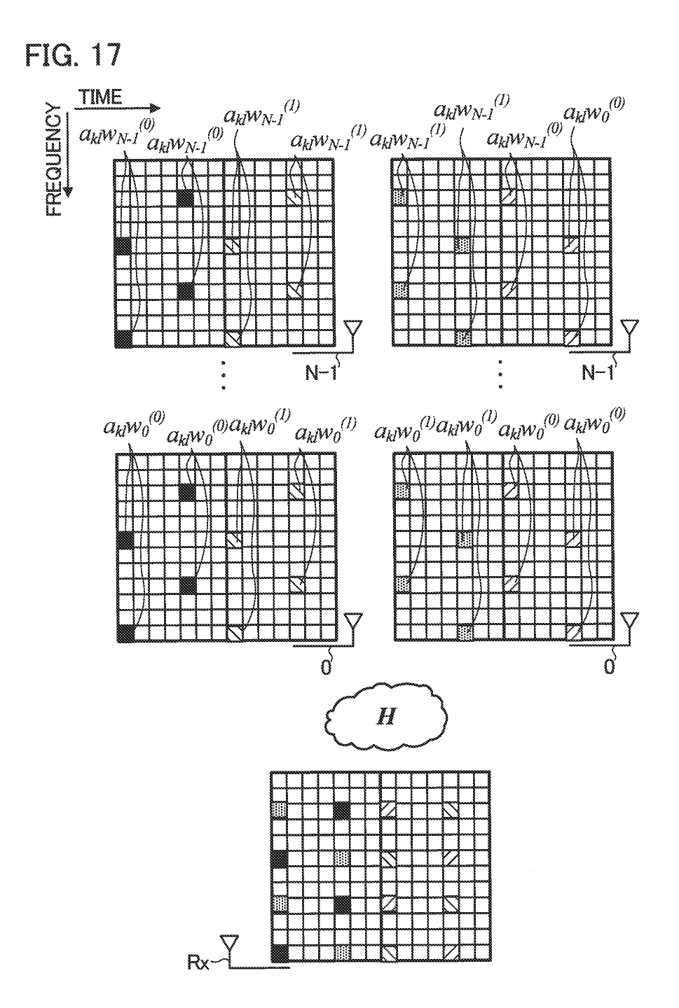

As for the mapping shown in. FIG. 16, more specifically, CRS symbol aₖₗ transmitted from antenna element 0 at a resource element position of transmission antenna port 0 by using beam 0 is multiplied by complex weight w₀⁽⁰⁾ as shown in FIG. 17. CRS symbol aₖₗ transmitted from antenna element N-1 at a resource element position of transmission antenna port 0 by using beam 0 is multiplied by complex weight w_{N-1}⁽⁰⁾. CRS symbol aₖₗ transmitted from antenna element 0 at a resource element position of transmission antenna port 0 by using beam 1 is multiplied by complex weight w₀⁽¹⁾, and CRS symbol aₖₗ transmitted from antenna element N-1 at a resource element position of transmission antenna port 0 by using beam 1 is multiplied by complex weight w_{N-1}⁽¹⁾. CRS symbol aₖₗ transmitted from antenna element 0 at a resource element position of transmission antenna port 1 by using beam 0 is multiplied by complex weight w₀⁽⁰⁾. CRS symbol aₖₗ transmitted from antenna element N-1 at a resource element position of transmission antenna port 1 by using beam 0 is multiplied by complex weight w_{N-1}⁽⁰⁾. CRS symbol aₖₗ transmitted from antenna element 0 at a resource element position of transmission antenna port 1 by using beam 1 is multiplied by complex weight w₀⁽¹⁾, and CRS symbol aₖₗ transmitted from antenna element N-1 at a resource element position of transmission antenna port 1 by using beam 1 is multiplied by complex weight w_{N-1}⁽¹⁾.

In this way, two CRS beams transmitted from each transmission antenna port (four CRS beams in total) are received by the reception antenna Rx of the UE via the transmission path indicated by H. The UE can measure the reception qualities of these four CRS beams, and perform CSI determination and reporting based on the reception qualities of the CRSs.

In the examples above, cases in which Precoded CRSs are transmitted using resource positions of transmission antenna ports 0 and/or 1 mainly have been described. However, it is also possible to transmit Precoded CRSs by using resource elements of transmission antenna ports 2 and/or 3, for example. In particular, since multi-antenna transmission using two transmission antennas is the mainstream in LTE systems, it is possible to eliminate (or reduce) the impact on legacy users by using antenna port 2 or 3 that has not been used yet.

Next, description will be given of a flow of processing according to the embodiments of the present invention.

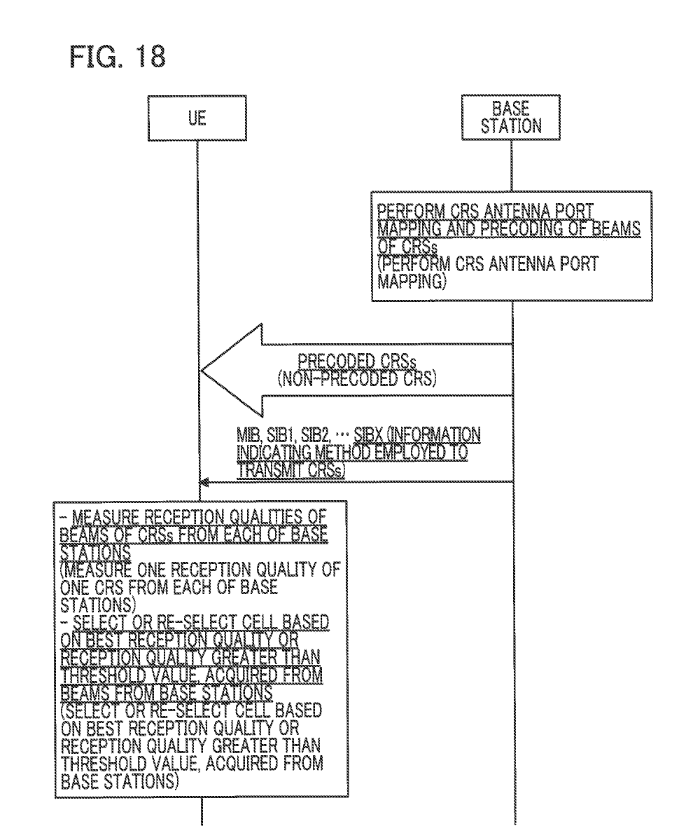

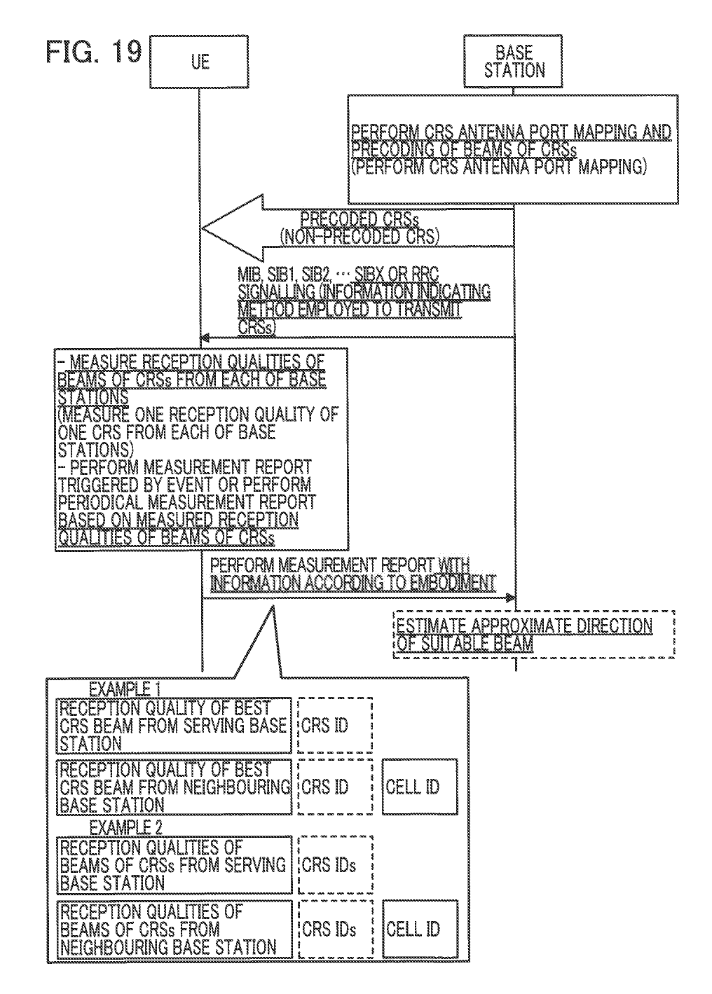

FIG. 18 is a sequence diagram showing a processing flow according to an embodiment when the UE is in the idle state (RRC_IDLE). In the drawing, the underlined portions indicate novel features according to the embodiment, and other portions indicate conventional functions. In the embodiment, each of the plurality of base stations performs transmission antenna port mapping of CRSs, precodes the plurality of CRSs, and transmits a plurality of beams of the precoded CRSs. Also, these base stations transmit information indicating a method employed to transmit the plurality of CRSs, using a novel SIB (denoted as SIBX) in addition to a MIB and a conventional SIB. The UE measures a plurality of reception qualities (e.g., RSRP or RSRQ) of the plurality of CRS beams from each of the plurality of base stations, and performs cell selection or re-selection based on the best reception quality or a reception quality that is greater than a threshold value, acquired from the plurality of beams from the plurality of base stations.

FIG. 19 is a sequence diagram showing processing according to an embodiment when the UE is in the connected state (RRC_CONNECTED). In the embodiment, each of the plurality of base stations performs a transmission-antenna-port based mapping of CRSs, precodes a plurality of CRSs, and transmits a plurality of beams of the precoded CRSs. Also, these base stations transmit information indicating a method employed to transmit the plurality of CRSs, using a novel SIBX or through RRC signaling, in addition to a MIB and a conventional SIB. The UE measures a plurality of reception qualities (e.g., RSRP or RSRQ) of a plurality of CRS beams from each of the plurality of base stations, and performs measurement report triggered by an event or a periodical measurement report based on the measurement of the plurality of reception qualities of the plurality of CRS beams.

The measurement report may indicate, for example, the reception quality of the best CRS beam out of the plurality of CRS beams from the serving base station, the reception quality of the best CRS beam out of the plurality of CRS beams from a neighbouring base station, and the cell ID of the neighbouring base station. If this is the case, the CRS ID of the best CRS beam from the serving base station and the CRS ID of the best CRS beam from the neighbouring base station may be indicated. The dotted squares in the drawings represent information elements or functions that may not have existed thus far.

Alternatively; the measurement report may indicate the plurality of reception qualities of the plurality of CRS beams from the serving base station, the plurality of reception qualities of the plurality of CRS beams from a neighbouring base station, and the cell ID of the neighbouring base station. If this is the case, the CRS IDs of the plurality of CRS beams from the serving base station and the CRS IDs of the plurality of CRS beams from the neighbouring base station may be indicated.

The serving base station receives the measurement report, and estimates an approximate direction of a beam suitable for the UE.

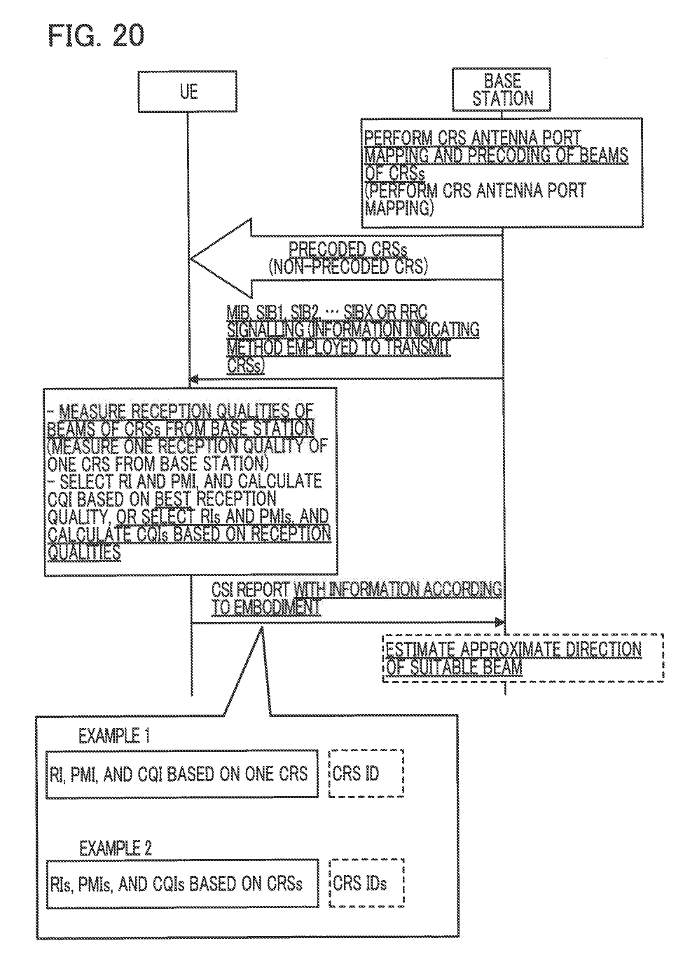

FIG. 20 is a sequence diagram showing a flow of CSI feedback processing based on the CRS according to an embodiment. In the embodiment, the serving base station performs transmission antenna port mapping of the CRS, precodes a plurality of CRSs, and transmits a plurality of beams of the precoded CRSs. Also, the serving base station transmits information indicating a method employed to transmit the plurality of CRSs, using a novel SIBX or through RRC signaling in addition to a MIB and a conventional SIB. The UE measures a plurality of reception qualities (e.g., SINRs) of the plurality of CRS beams from the serving base station.

Then, the UE selects an RI and a PMI based on the reception quality of the best CRS beam, and calculates a CQI. Alternatively, the UE may select a plurality of RIs and a plurality of PMIs based on the plurality of reception qualities of the plurality of CRS beams, and calculates a plurality of CQIs. The UE reports the RI, the PMI, and the CQI that are based on the reception quality of the best CRS beam, to the serving base station. If this is the case, the CRS ID of the best CRS beam may be indicated by the report. Alternatively, the UE reports the plurality of RIs, the plurality of PMIs, and the plurality of CQIs, which are based on the plurality of reception qualities of the plurality of CRS beams, to the serving base station. If this is the ease, the CRS IDs of the plurality of CRS beams may be indicated by the report.

A set of 3D MIMO antennas may be used to control the direction of a synchronization signal beam by giving a precoding matrix to each of the synchronization signals (PSS and SSS) and other signals for measurement, in the same manner as with the reference signals. Each base station may transmit 3D MIMO beams of a plurality of precoded PSSs in a format that allows the UE to distinguish between the plurality of precoded PSSs and between the base stations from which the plurality of precoded PSSs have been transmitted. Each base station may transmit 3D MIMO beams of a plurality of precoded SSSs in a format that allows the UE to distinguish between the plurality of precoded SSSs and between the base stations from which the plurality of precoded SSSs have been transmitted. The UE can connect with any of the base stations by using a precoded PSS and SSS.

A plurality of PSSs or a plurality of SSSs can be distinguished from one another based on time, frequency, spread code, space, a transmission antenna port, or a combination thereof. For example, it is useful to map a plurality of PSSs or a plurality of SSSs to different antenna elements (spaces). The precoding matrix used for precoding is constituted by complex weights. The existing rules (including sequence generation, demodulation, resource element allocation, and so on) can be used to generate the PSS and the SSS.

Transmitting, with a plurality of beams, the PSS and the SSS after precoding them improves the coverage of the UE within a three-dimensional space and increases the opportunity for the UE to synchronize with the system. For example, the PSS and the SSS reach a UE that is located obliquely above the base station, and the UE can then synchronize with the system.

Appropriately controlling the directions of beams for the PSS or the SSS allows the UE to synchronize with the system by using a PSS and an SSS in a beam that is in any one of the directions, which also allows the serving base station to learn an approximate direction of a beam that is good for the UE 100. The serving base station can also determine or correct the precoding matrix for data signals based on the information regarding the direction of the beam, which is good for the UE 100. For example, with the plurality of beams for PSSs and SSSs being allocated to different time periods, the UE can measure the electrical power of the plurality of beams for the PSSs and the SSSs, select the strongest beam for the PSS and the SSS, and notify the serving base station of the beam index.

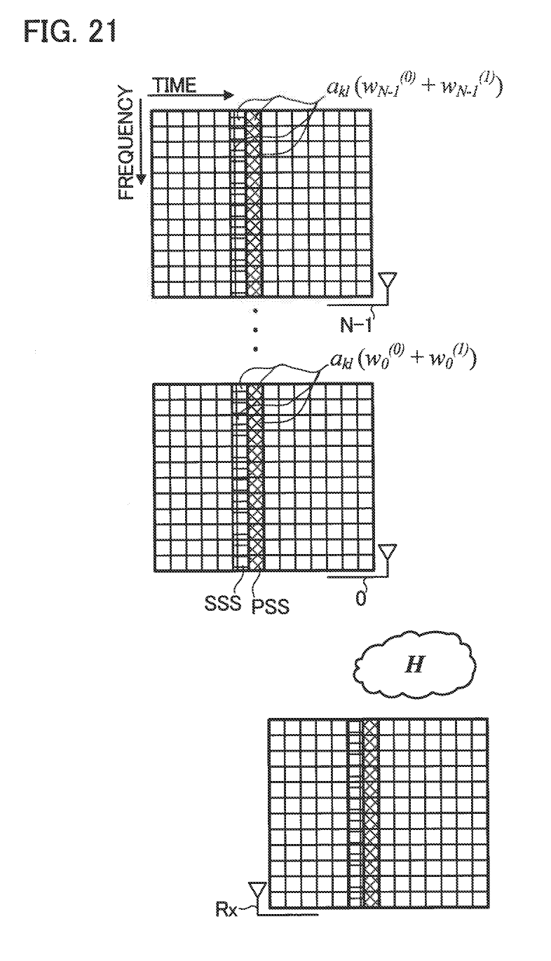

FIG. 21 is a diagram showing an example allocation, to different antenna elements, of a plurality of pairs of a PSS and a SSS that are transmitted from one transmission antenna port of one base station. In each antenna element, the SSS and PSS symbols aₖₗ are multiplied by a common complex weight (wₙ⁽⁰⁾+wₙ⁽¹⁾). Specifically, the PSS and SSS symbols aₖₗ transmitted from antenna element 0 are multiplied by complex weight w₀⁽⁰⁾+w₀⁽¹⁾. The PSS and SSS symbols aₖₗ transmitted from antenna element N-1 are multiplied by complex weight (w_{N-1}⁽⁰⁾+w_{N-1}⁽¹⁾). Therefore, from this transmission antenna port, a pair of a PSS and an SSS that have been precoded with a precoding matrix (vector in this example) W⁽⁰⁾ and a pair of PSS and SSS that have been precoded with a precoding matrix (vector in this example) W⁽¹⁾ are transmitted.

These precoding matrices are expressed by the following formulas.

$${W}^{( 0 )} = [ \begin{matrix}{w}_{0}^{( 0 )} \\ {w}_{I}^{( 0 )} \\ ⋮ \\ {w}_{N - I}^{( 0 )}\end{matrix} ] {W}^{( I )} = [ \begin{matrix}{w}_{0}^{( I )} \\ {w}_{I}^{( I )} \\ ⋮ \\ {w}_{N - I}^{( I )}\end{matrix} ]$$

In this way, two PSS and SSS beams that have been spatially separated from each other and have been transmitted from one transmission antenna port are received by the reception antenna Rx of the UE via the transmission path indicated by H. The UE can detect these two beams. The PSS and SSS symbols rₖₗ received by the UE are expressed by

r_{ld}=hₙ(W⁽⁰⁾+W⁽¹⁾)aₖₗ

where hₙ is a channel vector between the n^{th} transmission antenna element of the base station and the reception antenna element Rx of the UE.

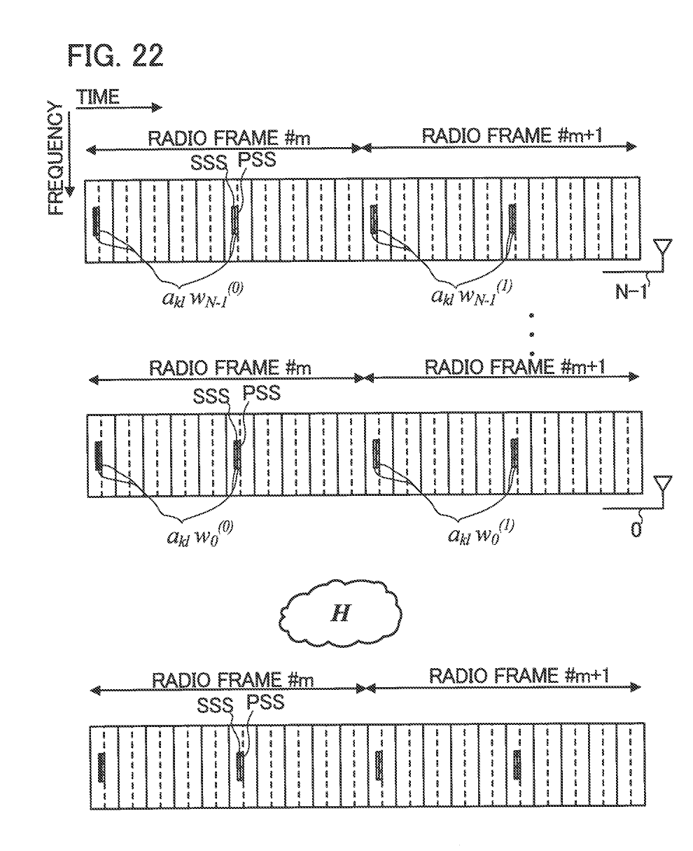

FIG. 22 is a diagram showing an example allocation, to different antenna elements, of a plurality of pairs of a PSS and an SSS that are transmitted on one transmission antenna port of one base station. In each antenna element, SSS and PSS symbols aₖₗ belonging to one radio frame are multiplied by a common complex weight wₙ⁽¹⁾. Specifically, PSS and SSS symbols aₖₗ transmitted from antenna element 0 using radio frame #m are multiplied by complex weight w₀⁽⁰⁾. PSS and SSS symbols aₖₗ transmitted from antenna element 0 using radio frame #m+1 are multiplied by complex weight w₀⁽¹⁾. PSS and SSS symbols aₖₗ transmitted from antenna element N-1 using radio frame #m are multiplied by complex weight w_{N-1}⁽⁰⁾. PSS and SSS symbols aₖₗ transmitted from antenna element N-1 using radio frame #m+1 are multiplied by complex weight w_{N-1}⁽¹⁾. Therefore, from this transmission antenna port, two pairs of a PSS and an SSS that have been precoded with a precoding matrix (vector in this example) W⁽⁰⁾ are transmitted during radio frame #m, and two pairs of a PSS and an SSS that have been precoded with a precoding matrix (vector in this example) W⁽¹⁾ are transmitted during radio frame #m+1.

These precoding matrices are expressed by the following formulas.

$${W}^{( 0 )} = [ \begin{matrix}{w}_{0}^{( 0 )} \\ {w}_{I}^{( 0 )} \\ ⋮ \\ {w}_{N - I}^{( 0 )}\end{matrix} ] {W}^{( I )} = [ \begin{matrix}{w}_{0}^{( I )} \\ {w}_{I}^{( I )} \\ ⋮ \\ {w}_{N - I}^{( I )}\end{matrix} ]$$

In this way, two PSS and SSS beams that have been spatially separated from each other and have been transmitted from one transmission antenna port are received by the reception antenna Rx of the UE via the transmission path indicated by H. Thereafter, the UE can acquire the system frame number with an MIB (Master Information Block), and notify the serving base station of the index of the beam corresponding to the radio frame number as of when the electrical power rises.

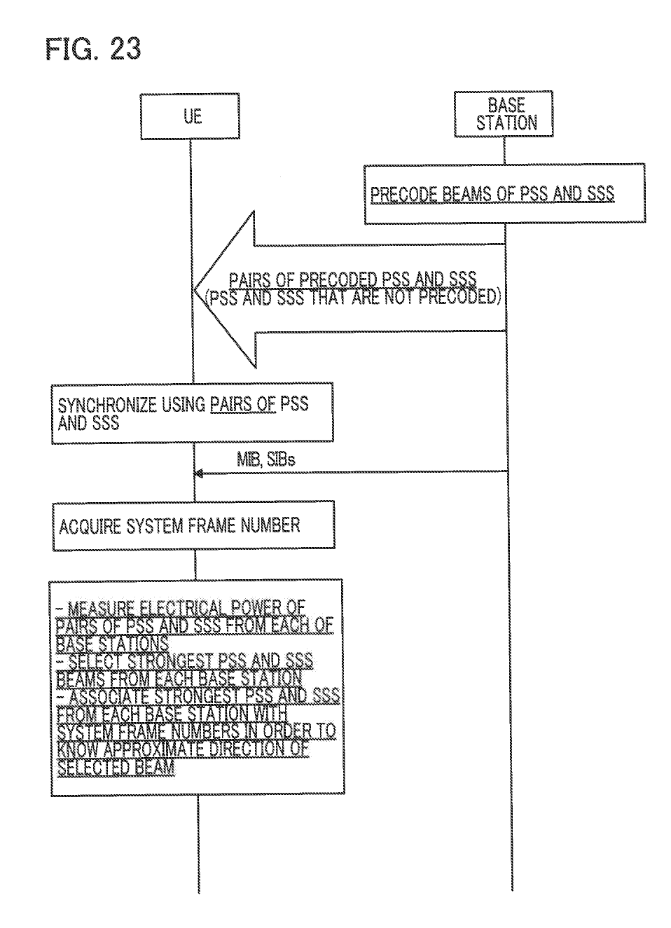

FIG. 23 is a sequence diagram showing a flow of processing performed by a UE to synchronize with a base station, according to an embodiment. In the drawing, the underlined portions indicate novel features according to an embodiment, and other portions indicate conventional functions. In the embodiment, each of a plurality of base stations precodes a plurality of PSS and SSS beams, and transmits a plurality of pairs of a PSS and an SSS that have been precoded. The UE synchronizes with a base station by using a plurality of pairs of a PSS and an SSS.

Thereafter, the UE acquires the system frame number with an MIB. Furthermore, the UE measures the electrical power of the plurality of pairs of a PSS and an SSS from each of the plurality of base stations. Next, the UE selects the strongest PSS and SSS beam from the respective base stations, and associates the strongest PSS and SSS from each base station with the system frame number, in order to find out the approximate directions of the selected beams.

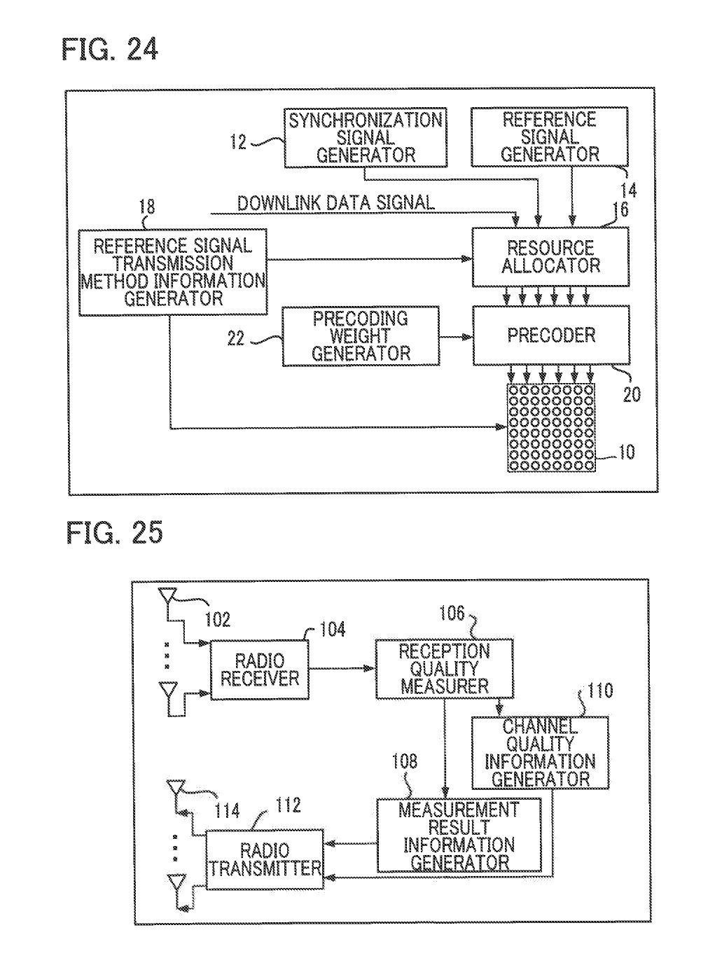

FIG. 24 shows a configuration of a base station according to an embodiment. FIG. 24 shows only a portion related to downlink transmission, and a portion related to uplink reception is omitted. Each base station is provided with an antenna set 10 for 3D MIMO, a synchronization signal generator 12, a reference signal generator 14, a resource allocator 16, a reference signal transmission method information generator 18, a precoder 20, and a precoding weight generator 22. As described above, the antenna set 10 is provided with a plurality of a transmission antenna ports. The synchronization signal generator 12, the reference signal generator 14, the resource allocator 16, the reference signal transmission method information generator 18, the precoder 20, and the precoding weight generator 22 are functional blocks that are realized by a CPU (Central Processing Unit) (not shown) of the base station executing a computer program stored in a storage (not shown) and functioning according to the computer program.

The synchronization signal generator 12 generates PSS and SSS sequences. The reference signal generator 14 generates a CRS sequence. The resource allocator 16 allocates antenna ports, antenna elements, resource elements, and other communication resources used for transmission, to downlink data signals, PSSs, SSSs, and CRSs. As a result, mapping corresponding to the plurality of pairs of a PSS and an SSS and also to a plurality of CRSs is generated.

The reference signal transmission method information generator 18 generates information indicating a method employed to transmit the above-described plurality of CRSs. The information indicating the method employed to transmit the plurality of CRSs is supplied to the resource allocator 16. The resource al locator 16 (a reference signal transmission controller) allocates antenna ports, antenna elements, resource elements, and other communication resources used for CRS transmission based on this information, and this allocation is made in a format that allows the UE to distinguish between the plurality of precoded CRSs, and to identify that the transmitter of the plurality of precoded CRSs is the subject base station. The reference signal transmission method information generator 18 supplies the antenna set 10 with at least a portion of the information indicating the method employed to transmit the plurality of CRSs (e.g., the IDs of the CRSs). The information indicating the method employed to transmit the plurality of CRSs is transmitted using an SIB or through RRC signaling.

The precoding weight generator 22 generates precoding weights for controlling the direction of a beam to be transmitted on transmission antenna ports. The precoder 20 (the reference signal transmission controller) precodes data signals, a plurality of pairs of a PSS and an SSS, and a plurality of CRSs by applying the precoding weights thereto, in order to adapt the data signals, the plurality of pairs of a PSS and an SSS, and the plurality of CRSs to a plurality of directions, and supplies them to the antenna set 10. Thus, a plurality of pairs of PSS and SSS beams and a plurality of CRS beams are generated. The precoded CRSs are transmitted on at least any one of the transmission antenna ports of the antenna set 10.

FIG. 25 shows a configuration of a UE according to an embodiment. FIG. 25 only shows a portion related to processing involved in receiving reference signals and synchronization signals, and other portions are omitted. The UE is provided with a plurality of reception antennas 102, a radio receiver 104, a reception quality measurer 106, a measurement result information generator 108, a channel quality information generator 110, a radio transmitter 112, and a plurality of transmission antennas 114. The radio receiver 104 is a radio receiver circuit, and the radio transmitter 112 is a radio transmitter circuit. The reception quality measurer 106, the measurement result information generator 108, and the channel quality information generator 110 are functional blocks that are realized by a CPU (not shown) of the UE executing a computer program stored in a storage (not shown), and functioning according to the computer program.

The radio receiver 104 receives data signals from a serving base station (or a plurality of coordinated base stations for CoMP). The radio receiver 104 also receives a plurality of pairs of a PSS and an SSS from each of a plurality of base stations in the network. The radio receiver 104 (a reference signal receiver) also receives a plurality of CRSs from each of the plurality of base stations in the network. The radio receiver 104 also receives information indicating the method employed to transmit the plurality of CRSs, using an SIB or through RRC signaling.

The reception quality measurer 106 specifies a plurality of CRSs according to the information indicating the method employed to transmit the plurality of CRSs, and measures the reception qualities thereof (e.g., RSRP or RSRQ and SINR). The measurement result information generator 108 generates information that directly indicates results of measurement of the reception qualities of the CRSs, or information that is based on the results of measurement, and transmits the information using the radio transmitter 112 (an information reporter) and the reception antennas 102. The details thereof are as described above.

The channel quality information generator 110 selects an RI and a PMI based on the reception quality (e.g., SINR) of the best CRS beam, calculates a CQI, and generates CSI that includes them. Alternatively, the UE may select a plurality of RIs and a plurality of PMIs based on the plurality of reception qualities of the plurality of CRS beams, calculate a plurality of CQIs, and generate a plurality of pieces of CSI. The radio transmitter 112 (the information reporter) and the reception antennas 102 report the CSI pieces to the network.

In the embodiment according to the present invention, each of base stations transmits a plurality of precoded reference signals, and a user equipment measures the reception qualities of the reference signals, in a manner that is adaptable to 3D MIMO. Therefore, it is possible to appropriately select a serving base station for the user equipment, and to estimate a direction of a beam suitable for the user equipment. The UE reports, to the network, CSI that is based on the best reception quality of the reference signals, and the serving base station determines, based on the CSI that has been fed back thereto, a rank number, a precoding matrix, and a CQI that are to be used, and performs frequency scheduling based on the determined CQI by using the determined rank number and precoding matrix, which correspond to the RI and the PMI, in a manner that is adaptable to 3D MIMO.

As described above, the destination of the report on the reception quality and the report on the CSI from the UE may be the current serving base station for the UE or the base station control apparatus 200 (see FIG. 6) that controls a plurality of base stations. In this regard, as described above, the current serving base station may be provided with the serving base station determiner, or the base station control apparatus 200 serves as the serving base station determiner.

### DESCRIPTION OF REFERENCE SIGNS

1, 2 base station
10 antenna set
12 synchronization signal generator
14 reference signal generator
16 resource allocator (reference signal transmission controller)
18 reference signal transmission method information generator
20 precoder (reference signal transmission controller)
22 precoding weight generator
100 user equipment (UE)
102 reception antenna
104 radio receiver (reference signal receiver)
106 reception quality measurer
108 measurement result information generator
110 channel quality information generator
112 radio transmitter (information reporter)
114 transmission antenna
200 base station control apparatus (serving base station determiner)

1. A base station comprising:
a plurality of transmission antenna ports;
a precoding weight generator configured to generate precoding weights for controlling directions of beams to be transmitted on at least one of the transmission antenna ports; and
a reference signal transmission controller configured to precode, with the precoding weights, a plurality of reference signals for measurements of reception qualities at a user equipment such that the plurality of reference signals are adapted respectively to a plurality of directions, and to transmit, on the at least one of the transmission antenna ports, the plurality of precoded reference signals in a format that allows the user equipment to distinguish between the plurality of reference signals.

2. A user equipment comprising:
a reference signal receiver configured to receive a plurality of reference signals from one base station or each of a plurality of base stations in a network, the plurality of reference signals having been precoded, at each base station, using precoding weights for controlling directions of beams to be transmitted on a plurality of transmission antenna ports, and the plurality of reference signals being directed in a plurality of directions;
a reception quality measurer configured to measure reception qualities of the plurality of reference signals; and
an information reporter configured to report, to the network, information based on the reception qualities of the plurality of reference signals, wherein the information is used for at least one of selection of at least one serving base station, for the user equipment, in the network and estimation of a direction of a beam suitable for the user equipment.

3. The user equipment according to claim 2, further comprising
a channel quality information generator configured to generate channel quality information based on a best reception quality among the reception qualities of the plurality of reference signals from the at least one serving base station, wherein the channel quality information includes a rank indicator, a precoding matrix indicator, and a channel quality indicator,
wherein the information reporter reports the channel quality information to the network:

4. A radio communication network comprising:
a plurality of base stations, each comprising:
a plurality of transmission antenna ports;
a precoding weight generator configured to generate precoding weights for controlling directions of beams to be transmitted on at least one of the transmission antenna ports; and
a reference signal transmission controller configured to precode, with the precoding weights, a plurality of reference signals for measurements of reception qualities at a user equipment such that the plurality of reference signals are adapted respectively to a plurality of directions, and to transmit, on the at least one of the transmission antenna ports, the plurality of precoded reference signals in a format that allows the user equipment to distinguish between the plurality of reference signals; and
a serving base station determiner configured to determine at least one serving base station for the user equipment, based on results of measurements, at the user equipment, of reception qualities of the plurality of reference signals from the plurality of base stations.
